(19) United States
(12) Patent Application Publication
(10) Pub. No.: US 2025/0182490 A1
(43) Pub. Date: Jun. 5, 2025

(54) AUTOMATIC DIGITAL INSPECTION OF RAILWAY ENVIRONMENT

(71) Applicant: HACK PARTNERS LIMITED, Devizes (GB)

(72) Inventors: Sebastian Adam KAY, London (GB); Andre Luiz Nunes TARGINO DA COSTA, London (GB); Alireza PARANDEH, London (GB)

(73) Assignee: HACK PARTNERS LIMITED, Devizes (GB)

(21) Appl. No.: 18/842,445

(22) PCT Filed: Feb. 28, 2023
(86) PCT No.: PCT/IB2023/051849

§ 371 Date: Aug. 29, 2024

(30) Foreign Application Priority Data
Mar. 2, 2022 (GB) 2202920.1

(51) Int. Cl. G06V 20/56; B61L 23/04; G06V 10/25; G06V 10/26; G06V 10/70; G06V 20/10; G06V 20/40

(52) U.S. Cl. CPC G06V 20/56; B61L 23/04; G06V 10/25; G06V 10/26; G06V 10/70; G06V 20/188; G06V 20/41

(57) ABSTRACT

Disclosed is a method for automatic digital inspection of a railway environment. The method comprising receiving at least a first video captured by at least one camera mounted on a rail vehicle, wherein the first video comprises video frames representing the railway environment; generating point clouds using the video frames, wherein a given point cloud correspond to a given set of video frames; attributing labels to each pixel of the video frames for generating annotated video frames; evaluating the annotated video frames and their corresponding point clouds using a set of predefined rules to at least determine whether or not at least one violation is present in the railway environment; generating inspection information related to at least one violation, when it is determined that at least one violation is present in the railway environment; and sending the inspection information to a user device.

### TECHNICAL FIELD

This invention relates to railway assets. In particular, though not exclusively, this invention relates to a method for automatic digital inspection of a railway environment and a system for automatic digital inspection of a railway environment.

### BACKGROUND

Normally, maintenance of railway assets is a key component in the railway industry. The maintenance of the railway assets is performed by maintenance workers to ensure that entire railway infrastructure is safe and reliable, by carrying out inspections related to signalling and power supplies, railway tracks and bridges, embankments, fences, level crossings, railway environment, safe cess paths and so forth. In this regard, intelligent software is used to collect and analyse data about usage so that predictive and preventative maintenance can be carried out rather than reactive repairs.

Conventionally, manual inspections may be used to inspect the railway assets along the railway tracks. Herein, the manual inspections involve the maintenance workers walking the railway tracks or riding in train cabs to spot defects across a range of the railway assets on lineside. The defects may be at least one: scrap rail, unwanted vegetation, damaged and/or obscured signs, damaged and/or obscured signals, graffiti and overhead line assets. However, said manual inspections are time consuming, unsafe, and inaccurate. Herein, the manual inspections are inaccurate since the maintenance workers visually inspect and measure conditions of the railway assets, along with encroachments and/or distance and location along the railway infrastructure. Furthermore, the maintenance workers walk the railway tracks and may be struck by rail vehicles. Additionally, the maintenance workers use pen and paper, cellular devices comprising at least one camera, such as mobile phones and mobile tablets, to record data and manually review data captured by the cellular devices.

Therefore, in light of the foregoing discussion, there exists a need to overcome the aforementioned drawbacks associated with inspection of the railway assets.

### SUMMARY OF THE INVENTION

A first aspect of the invention provides a method for automatic digital inspection of a railway environment comprising:
receiving at least a first video captured by at least one camera mounted on a rail vehicle, wherein the first video comprises video frames representing the railway environment;
generating point clouds using the video frames, wherein a given point cloud correspond to a given set of video frames;
attributing labels to each pixel of the video frames for generating annotated video frames;
evaluating the annotated video frames and their corresponding point clouds using a set of predefined rules to at least determine whether or not at least one violation is present in the railway environment;
generating inspection information related to the at least one violation, when it is determined that the at least one violation is present in the railway environment; and
sending the inspection information to a user device.

At least the first video is captured by the at least one camera and is received therefrom. In this regard, by “at least one camera” it is meant that in some implementations, the at least the first video is captured by a single camera whereas in other implementations, the at least the first video is captured by a plurality of cameras. Herein, correct capturing of the first video depends on attributes associated with the at least one camera. The attributes associated with the at least one camera may be, depth of field of view, motion blur, shutter speed, aperture, distortion of lens, resolution, focal length, frames per second (FPS) and so forth. The at least one camera may be selected in a manner that it captures high-quality (i.e., high resolution) video frames. In an embodiment, the at least one camera is implemented as a visible-light camera. As an example, the at least one camera may be implemented as at least one of: a stereo camera, a Red-Green-Blue (RGB) camera, a RGB-Depth (RGB-D) camera, a monochrome camera. In another embodiment, the at least one camera is implemented as an infrared-light camera. Optionally, the at least one camera may be a depth camera. Examples of the depth cameras include, but are not limited to, a stereo camera, a ranging camera, a Time-of-Flight (ToF) camera, a Sound Navigation and Ranging (SONAR) camera, and a laser rangefinder. The at least one camera is mounted on the rail vehicle in a manner so that the railway environment is in the field of view of the camera. In this regard, it is feasible to mount the at least one camera elsewhere. The first video comprises the video frames captured at different instances of time. In other words, the first video comprises a sequence of the video frames.

In this regard, “video frames” refers to the sequence of images captured by a camera which may be viewed consecutively as a video. A video frame refers to one image captured by a camera. A video frame may also be referred to as an “image frame” or a “sequence frame”.

Advantageously, the video frames are captured to get a clear view of the railway environment. Herein, the railway environment comprises, but is not limited to, a railway station, at least one platform, railway track, a station building, passengers occasionally boarding or leaving the rail vehicle, signs, vegetation, overhead lines.

Optionally, the video frames are generated by creating a wrapper to extract the video frames from the first video. In this regard, a software, such as FFmpeg may be used for processing the first video. The first video captured from the at least one camera is split into several video frames.

A point cloud is a visualisation made up of a set of points in space, wherein the points may represent objects. An object may be visualised as a one-dimensional (1D) object, or as a two-dimensional object (2D), or as a three-dimensional (3D) object. Herein, a given point is made up of a corresponding set of Cartesian coordinates (i.e., X, Y and Z coordinates). Advantageously, the point cloud can provide a representation of the 3D object in high-resolution, without distortion. Furthermore, the point cloud may be composed of points measured on the external surface of the objects present in the video frames.

Optionally, the step of generating point clouds using the video frames employs at least one computer vision technique. In an embodiment, in case a given camera that captures 2D images is used, the point cloud can be generated using a Structure from Motion (SfM) technique, wherein a SfM technique can be wrapped using the OpenSfM library. In this regard, a Structure from Motion (SfM) technique is employed. The OpenSfM library is used to generate the point clouds from the video frames, wherein a the given point cloud corresponds to a the given set of video frames. The OpenSfM library can be used to find relative positions of objects in the video frames and to help create smooth transitions between the video frames, by matching the points between the video frames, and then determining 3D positions of those points in the point cloud. In an embodiment, in case the given camera that captures 3D data is used, then the point clouds are generated by processing the 3D data.

It will be appreciated that each pixel can represent a part of an object that can be classified into a class and the object is identifiable unambiguously. Suitably, semantic segmentation treats multiple objects of the same class as a single entity. The video frames are made up of points that are rendered as pixels, and each pixel of the video frames is assigned a label from a predefined set of classes using semantic segmentation, such as vegetation, railway track, signs and so forth. Herein, the label indicates a type of object, such as trees, rail car units, buildings, signals etc. In a first approach, each pixel is classified individually disregarding the label assigned to the other pixels of the video frames. In a second approach, each pixel is classified based on labels of its neighbouring pixels. In a third approach, each pixel of the video frames is labelled jointly by defining a class regarding the pixels, therefore generating the annotated video frames. Subsequently, upon labelling the pixels in the video frame, an annotated video frame is generated. For example, a video frame may comprise a railway track, vegetation, sign, and sky. The video frame may be composed of 1000 pixels. Subsequently, upon semantic segmentation, 250 pixels of the video frame may be attributed as railway track, 250 pixels of the video frame may be attributed as vegetation, 100 pixels of the video frame may be attributed as sign, and 400 pixels of the video frame may be attributed as sky, thereby generating an annotated video frame version of the video frame.

Optionally, the step of evaluating the annotated video frames and their corresponding point clouds may comprise:
detecting the railway track in the annotated video frames and their corresponding point clouds, and drawing a bounding box in the annotated video frames, wherein the bounding box may be fitted to the railway track;
associating the labels attributed to pixels of the annotated video frames to corresponding points within the point clouds; and
determining that the at least one violation may be present in the railway environment when violation conditions specified in the set of predefined rules is satisfied in respect to the bounding box.

Herein, a given bounding box is defined by ‘x’ and ‘y’ coordinates of its vertices to describe a spatial location of its corresponding object in a given video frame. In this regard, object detection models may be used to detect the railway track in the annotated video frames and their corresponding point clouds. Object detection models are well-known in the art. The ‘x’ and ‘y’ coordinates of the bounding box help determine location of the railway track. The labels attributed to the pixels of the annotated video frames enable a given object to spatially associate with respect to other objects in the railway environment. Herein, the set of predefined rules describe the violation conditions. In case any one of the set of predefined rules is satisfied, it signifies that a violation condition has been met. In case any obstruction is detected in the surroundings of a railway track (in particular, of the bounding box), the obstruction results in a violation condition being met with respect to the bounding box.

The annotated video frames and their corresponding points are thoroughly examined to determine presence of at least one violation present in the railway environment, as sometimes the annotated video frame may turn out to be a completely normal image. The term “violation” encompasses one or more of: presence of a non-compliant asset that does not comply with industry standards in the railway environment such as hazardous conditions in the railway environment, unwanted obstructions along the railway track. In an embodiment, the step of evaluating the annotated video frames and their corresponding point clouds using the at least one predefined rule is performed to also determine whether or not passengers are present in the railway environment. When it is detected that the passengers are present in the railway environment, the method further comprises counting a number of the passengers.

Optionally, the set of predefined rules may comprise at least one geometric rule and/or at least one custom-defined rule. The set of predefined rules comprise at least one of:
determining that a high lineside violation may be present when vegetation is present in a first space that is defined by two planes extending obliquely within a predefined distance from two rails of a railway track,
determining that an overhead vegetation violation may be present when vegetation is present in a second space lying vertically above the railway track;
determining that a sign violation may be present when a given sign in the railway environment is at least one of: obscured by another object, unreadable, vandalised;
determining that a signal violation may be present when a given signal in the railway environment is at least one of: obscured by another object, malfunctioning, vandalised;
determining that a safe cess violation may be present when a cess adjacent to the railway track is obstructed at least partially such that a distance between a non-obstructed region of the cess and the railway track is less than a predefined safety distance; and
determining that a scrap violation may be present when scrap is present on or in proximity of the railway track.

In this regard, the at least one geometric rule may depend on a perspective of the at least one camera while capturing the first video of the railway environment. The at least one geometric rule may depend on position, colour or brightness (i.e., in case a monochrome camera is used) of each pixel of the video frames. The custom-defined rule may be manually defined by the user, or may be automatically generated by the system, or may be a combination of both.

Optionally, the high lineside violation occurs when any unwanted object is too close to the railway tracks. The first space is a space lying in close proximity to the railway track, and when any unwanted object is present in the first space, the high lineside violation occurs. An extent of the first space is defined by the two planes and the predefined distance. An angle between a given plane corresponding to a given rail and a ground surface lies within a range of 30 degrees to 60 degrees. As an example, the angle between a given plane corresponding to a given rail and a ground surface may be 45 degrees. The angle between the given plane corresponding to the given rail and the ground surface may be in a range of from 30 to 40 degrees, or from 30 to 50 degrees, or from 30 to 60 degrees, or from 40 to 50 degrees, or from 40 to 60 degrees, or from 50 to 60 degrees. Correspondingly, an angle between a rail vehicle and the given plane may lie within a range of 60 degrees to 30 degrees. A high lineside violation occurs when an object in the latter space between a plane and a rail vehicle.

Optionally, the predefined distance may lie in a range of 0 to 5 metres. The predefined distance may be in a range of from 0 to 3 metres, or from 0 to 4 metres, or from 0 to 5 metres, or from 1 to 4 metres, or from 3 to 5 metres, or from 4 to 5 metres. For example, the predefined distance may be 2 metres. In case, a first object is at a distance of 0.5 metres from the railway track, then the high lineside violation occurs. However, in case a second object is at a distance of 2.5 metres from the railway track, then the high lineside violation does not occur.

Optionally, a given video frame comprises a pixel representation of the vegetation and a pixel representation of the railway track. Subsequently, the given video frame and the corresponding point cloud are used to determine spatial relationship between the pixel representation of the vegetation and the pixel representation of the railway track, wherein the pixel representation of the vegetation is determined to spatially lie above the pixel representation of the railway track. Therefore, the overhead vegetation violation occurs.

Optionally, the sign violation may be determined when size of the given sign is less than expected in the video frame, or the given sign is not visible in the video frame, or visual detail of the given sign is incomprehensible, or similar. Herein, size and location of the signs may be pre-known. The given sign is deemed unreadable due to weathering or vandalization, upon comparing the given sign with reference images of the given sign.

Optionally, signal violation may be determined when a given signal is not visible in the video frame, or the given signal looks different (from an expected appearance) when compared to the reference images related to a functioning signal. The given signal may not be visible in the video frame, or visual detail of the given signal is incomprehensible, or similar. Herein, size, location and function of the given signal may be pre-known.

The safe cess can optionally be understood to be a virtual tunnel (i.e., a virtually-defined space) adjacent to the railway track which ideally should be clear of obstructions, such as vegetation, ballast bags, structures and so forth. The safe cess allows track workers to safely transit the railway environment at a predefined safety distance from the railway track. The safe cess violation is undesirable as it puts the track workers at risk of being too close to the railway track, which could lead to injury or loss of life. A distance between the non-obstructed region of the cess and the railway track can be determined by the pixels in the video frames and their corresponding point clouds.

Optionally, the scrap may consist of unused railway assets such as, but not limited to, sleepers, fixtures, fish plates, condemned coaches, wagons and so forth. Presence of the scrap on or in proximity of the railway track endangers safe functioning of the rail vehicle.

Optionally, the predefined safety distance may depend on a maximum speed at which the rail vehicle is permitted to run on the railway track, and wherein:
the predefined safety distance may lie in a range of 2 metres to 2.75 metres when the maximum speed is equal to or greater than 100 miles per hour; and
the predefined safety distance may lie in a range of 1.25 metres to 2 metres when the maximum speed is less than 100 miles per hour.

In this regard, greater the maximum speed at which the rail vehicle is permitted to run on the railway track, higher is the predefined safety distance. The predefined safety distance may be in a range of from 2 to 2.50 metres, or from 2 to 2.75 metres, or from 2.25 to 2.75 metres, when the maximum speed is equal to or greater than 100 miles per hour. The predefined safety may be in a range of from 1.25 to 1.75 metres, or from 1.25 to 2 metres, or from 1.50 to 2 metres. As a first example, when the maximum speed is equal to or greater than 100 miles per hour, then the track workers should be at least 2.4 metres away from the given rail of the railway track. Conversely, when the maximum speed is less than 100 miles per hour, the track workers should be at least 1.30 metres away from the given rail of the railway track.

The video frames representing (namely, depicting) at least one violation are compiled to generate the inspection information. The term “inspection information” refers to information which helps to identify the at least one violation present in the railway environment. With the help of the inspection information, the at least one violation may subsequently be rectified either manually and/or automatically, and/or a combination of both.

Optionally, the inspection information may be in form of at least one of:
an annotated image representing the at least one violation and its bounding box;
a file including at least one property of the at least one violation, wherein the at least one property is at least one of: a type, a location, a size, a time-point of occurrence in the first video, of the at least one violation.

In this regard, the annotated image labels the objects which represents the at least one violation that helps to recognize the at least one violation. Herein, the at least one violation and its bounding box may be annotated using text, annotation tools, or a combination of both, to show the objects that comprise the at least one violation. Herein, annotation of a given image representing the at least one violation may be generated by at least one processor. A user may manually supplement annotations generated by the at least one processor. The annotated image may be used to further develop rules for detecting violations. The file may also include metadata of the annotated image, such metadata including coordinates of the bounding box. The file may be of any suitable format, not limited to only a text file.

Throughout the present disclosure, the term “user device” refers to an electronic device that is capable of displaying visual content. The visual content may be at least the inspection information. The user device is associated with (or used by) a user and is capable of enabling the user to perform specific tasks associated with the method. Furthermore, the display device is intended to be broadly interpreted to include any electronic device that may be used to facilitate decision-making of the user, by at least displaying the visual content. Examples of the user device include, but are not limited to, laptop computers, personal computers, cellular phones, personal digital assistants (PDAs), handheld devices etc. Additionally, the user device may include a casing, a memory, a processor, a network interface card, a microphone, a speaker, a keypad, and a display. Advantageously, the user device displays output of all the steps in the method of the invention.

Optionally, the method may further comprise:
generating a second video comprising a plurality of annotated video frames that depict at least one violation, based on the inspection information; and
sending the second video to the user device.

In this regard, the second video compiles the plurality of annotated video frames depicting the at least one violation and is viewed on the user device as an overview of the at least one violation. For example, a first video may comprise 200 video frames (which may be subsequently annotated), out of which 50 annotated video frames may depict at least one violation. Consequently, the 50 annotated video frames depicting at least one violation are used to generate the second video.

Optionally, the method may further comprise adding one or more video frames of the first video in the second video. Herein, the video frames of the first video are used to fill gaps in case one or more video frames is/are not present in the second video. In such a case where no video frame in the second video represents such a frame, the one or more video frame of the first video that represents such a frame is added to the second video. Advantageously, the one or more video frames required in the second video are stitched in with the help of the first video.

Optionally, the method may further comprise:
merging detections in the second video that depict the same violation into a single detection, based on the location of the at least one detection and its bounding box and on a temporal adjacency between the detections in the second video, to obtain a third video, wherein the third video comprises a lesser number of detections as compared to the second video; and
sending the third video to the user device for display thereat.

In this regard, the detections of the second video are too dense since the inspection information related to one violation is present in multiple video frames. However, this results in more detections in the second video to the user than is useful, as several video frames of the second video would depict the same violation. For instance, a railway environment may comprise a railway track, vegetation and a safe cess. There may be a length of the railway track where the vegetation heavily obstructs the safe cess. Herein, a bounding box is drawn around the vegetation heavily obstructing the safe cess. The safe cess violation may be represented by 1 detection in 10 video frames of the second video. Hence, these 10 detections from said length of the railway track are merged into a single detection and labelled as a single violation in a third video to the user, as the second video shows the same violation in 10 video frames. The third video is sent to the user device for the user to make decisions. Advantageously, the technical effect of such merging leads to a reduction of redundant detections. Furthermore, the third video will have only distinct and meaningful detections depicting the at least one violation, thereby enabling ease of further analysis.

Optionally, the method may comprise receiving LiDAR data captured by a LiDAR scanner, wherein the LiDAR data may be used for generating the point clouds and for evaluating the annotated video frames and their corresponding point clouds. An example of the LiDAR scanner may include, but is not limited to, a Light Detection and Ranging (LiDAR) camera, and a flash LiDAR camera. The LiDAR scanner comprises a source that laser (wherein, the laser comprises light pulses) to ping off objects in the railway environment and return to the source of the LiDAR scanner, thereby measuring distance by time of flight of light pulse in the laser.

Herein, LiDAR data comprises dense and accurate elevation data across landscapes, shallow-water areas and project sites in the railway environment. Furthermore, the LiDAR data is collected from stationary and mobile platforms. The LiDAR data is processed and organised to generate point clouds. Herein, the point clouds generated using LiDAR data are large collections of 3D elevation points, which include 3D coordinates along with additional attributes such as Global Positioning System (GPS) timestamps. The point cloud corresponds to the video frame, and each point in the point cloud corresponds to one or more pixels in the video frame. Each pixel of the video frames is labelled to generate annotated video frames. The annotated video frames and their corresponding point clouds are further evaluated to classify the objects in the video frames.

Optionally, the method may comprise training an image segmentation model using a machine learning algorithm, wherein upon training, the image segmentation model learns to perform the step of attributing the labels to each pixel of the video frames for generating the annotated video frames. The image segmentation model may be a deep learning model. The training of the image segmentation model is performed using reference images of the railway environment. Herein, the reference images are annotated and then used for training of the image segmentation model, wherein the annotated reference images depict objects such as trees, buildings, vehicles, people and so forth, in said environment. The machine learning algorithm may be, but not limited to, a clustering-based segmentation algorithm, a neural-network-based segmentation algorithm, and so forth. The image segmentation model can be a deep learning model that is trained to determine the objects present in the railway environment and also assign the same label to the pixels corresponding to a given object in the video frame.

Optionally, the method further comprises visually indicating a given violation in the second video and/or the third video. Optionally, in this regard, different types of violations may be indicated with different colours. As an example, pixels representing a safe cess violation as vegetation that heavily obstructs the safe cess, may be indicated in red colour; whereas pixels representing an overhead vegetation violation as vegetation present above the railway track, may be indicated in blue colour. A technical effect of providing such visual indication is that it makes identification of violations in the second video and/or the third video very convenient.

Optionally, the method further comprises:
determining at least one corrective task that is to be implemented to mitigate the at least one violation; and
sending a communication pertaining to the at least one corrective task, to the user device.

In this regard, the step of determining the at least one corrective task may be performed using a list of corrective tasks corresponding to violations. The at least one corrective task to be implemented depends on a type of the at least one violation, and may also depend on at least one of: a severity of the at least one violation, urgency of mitigating the at least one violation, availability of resources for implementing the at least one corrective task, and the like. For example, the at least one corrective task in an event of a safe cess violation by obstructive vegetation may be to clear off such vegetation that is obstructing the safe cess, to ensure clear passage for rail workers. Examples of communication pertaining to the at least one corrective task sent to the user device may be, but not limited to a visual indication, a text notification, an alarm, and so forth. Upon receiving such communication, the at least one corrective task may be initiated.

A second aspect of the invention provides a system for automatic digital inspection of a railway environment, according to a method of the first aspect, the system comprising:
at least one camera that is configured to capture a first video, wherein the first video comprises video frames representing the railway environment; and
at least one processor communicably coupled to the at least one camera, wherein the at least one processor is configured to execute steps of the method.

Throughout the present disclosure, the term “processor” relates to a computational element that is operable to respond to and process instructions. The at least one processor, in operation, implements the method for automatic digital inspection of the railway environment. Furthermore, the term “processor” may refer to one or more individual processors, processing devices and various elements associated with a processing device that may be shared by other processing devices. Such processors, processing devices and elements may be arranged in various architectures for responding to and executing the steps of the method.

Optionally, the at least one camera may be mounted on at least one of:
a side of a rail vehicle;
a fixed object present in the railway environment; and
a movable object present in the railway environment.

In this regard, the at least one camera may be mounted on the side of the rail vehicle to provide a view of surroundings in the proximity of the railway track in the railway environment. The side of the rail vehicle may be one or more of: a front side, a top side, a left side, a right side, a back side, an underside, of the rail vehicle. The fixed object present in the railway environment may be an infrastructure element, such as a building, a pole, bridges, tunnel and so forth. The movable object present in the railway environment may comprise a drone, a robot and so forth, used for monitoring the railway environment.

Optionally, the system may further comprise a data repository communicably coupled to the at least one processor and/or the at least one camera, wherein the data repository is configured to store at least one of: the first video, point clouds generated using the video frames, labels attributed to each pixel of the video frames, a set of predefined rules, inspection information, a second video, a third video. The term “data repository” refers to hardware, software, firmware, or a combination of these for storing a given information in an organised (namely, structured) manner, thereby, allowing for easy storage, access (namely, retrieval), updating and analysis of the given information. The data repository may be implemented as a memory of a device (such as the imaging system, the display apparatus, or similar), a removable memory, a cloud-based database, or similar. The data repository can be implemented as one or more storage devices. A technical effect of using the data repository is that it provides an ease of storage and access of processing inputs, as well as processing outputs.

A third aspect of the invention provides a computer program product for automatic digital inspection of a railway environment, the computer program product comprising a non-transitory machine-readable data storage medium having stored thereon program instructions that, when accessed by a processing device, cause the processing device to execute steps of a method of the first aspect. The term “computer program product” refers to a software product comprising program instructions that are recorded on the non-transitory machine-readable data storage medium, wherein the software product is executable upon a computing hardware for implementing the aforementioned steps of the method for automatic digital inspection of the railway environment.

In an embodiment, the non-transitory machine-readable data storage medium can direct a machine (such as computer, other programmable data processing apparatus, or other devices) to function in a particular manner, such that the program instructions stored in the non-transitory machine-readable data storage medium case a series of steps to implement the function specified in a flowchart corresponding to the instructions. Examples of the non-transitory machine-readable data storage medium includes, but is not limited to, an electronic storage device, a magnetic storage device, an optical storage device, an electromagnetic storage device, a semiconductor storage device, a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, or any suitable combination thereof.

Throughout the description and claims of this specification, the words “comprise” and “contain” and variations of the words, for example “comprising” and “comprises”, mean “including but not limited to”, and do not exclude other components, integers or steps. Moreover, the singular encompasses the plural unless the context otherwise requires: in particular, where the indefinite article is used, the specification is to be understood as contemplating plurality as well as singularity, unless the context requires otherwise.

Preferred features of each aspect of the invention may be as described in connection with any of the other aspects. Within the scope of this application, it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible.

### BRIEF DESCRIPTION OF THE DRAWINGS

One or more embodiments of the invention will now be described, by way of example only, with reference to the following diagrams wherein:

FIG. 1 is an illustration of a flowchart depicting steps of a method for automatic digital inspection of a railway environment, in accordance with an embodiment of the present disclosure;

FIG. 2 is a block diagram representing a system for automatic digital inspection of a railway environment, in accordance with an embodiment of the present disclosure;

FIG. 3 is an exemplary process flow for automatic digital inspection of a railway environment, in accordance with an embodiment of the present disclosure;

FIG. 4 is an exemplary railway environment, in accordance with an embodiment of the present disclosure;

FIG. 5 are exemplary violations in a railway environment, in accordance with an embodiment of the present disclosure; and

FIG. 6 is an exemplary safe cess in a railway environment, in accordance with an embodiment of the present disclosure.

### DETAILED DESCRIPTION

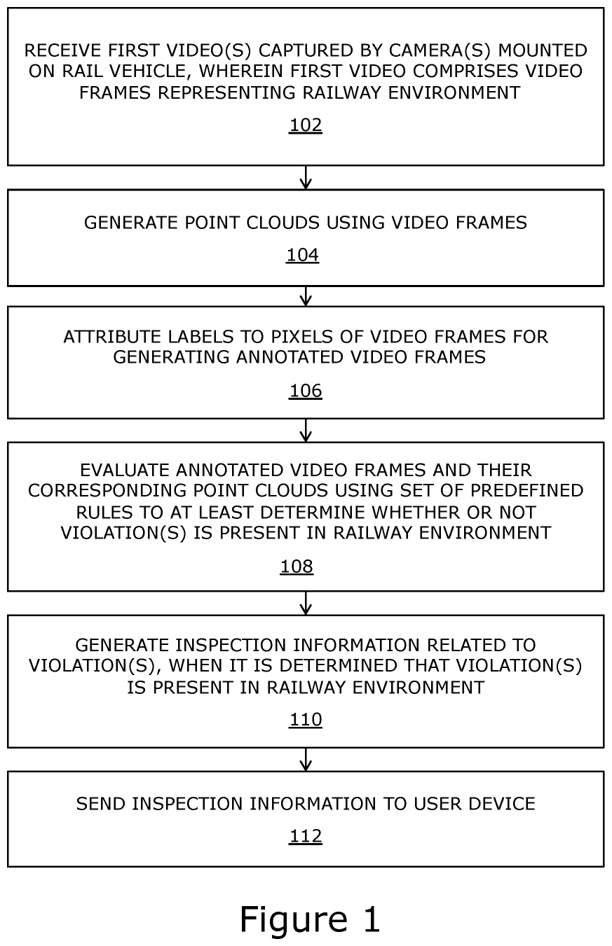

Referring to FIG. 1, illustrated is a flowchart depicting steps of a method for automatic digital inspection of a railway environment, in accordance with an embodiment of the present disclosure. At step 102, at least a first video is captured by at least one camera mounted on a rail vehicle is received, wherein the first video comprises video frames representing the railway environment. At step 104, point clouds are generated using the video frames, wherein a given point cloud corresponds to a given set of video frames. At step 106, labels are attributed to each pixel of the video frames for generating annotated video frames. At step 108, the annotated video frames are evaluated and their corresponding point clouds using a set of predefined rules to at least determine whether or not at least one violation is present in the railway environment. At step 110, inspection information is generated related to the at least one violation, when it is determined that the at least one violation is present in the railway environment. At step 112, the inspection information is sent to a user device.

The aforementioned steps are only illustrative and other alternatives can also be provided where one or more steps are added, one or more steps are removed, or one or more steps are provided in a different sequence without departing from the scope of the claims herein.

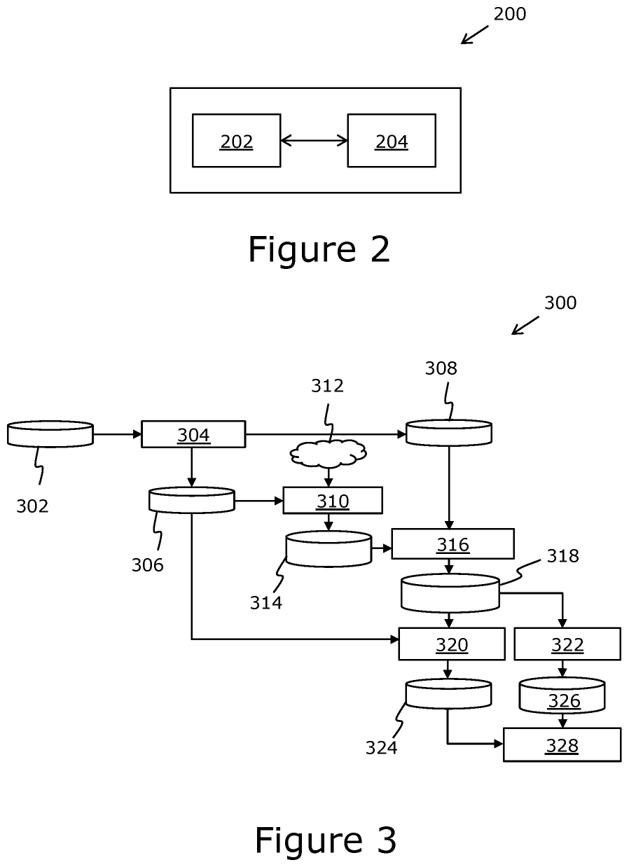

Referring to FIG. 2, there is shown a block diagram representing a system 200 for automatic digital inspection of a railway environment, in accordance with an embodiment of the present disclosure. The system 200 comprises at least one camera 202 and at least one processor 204. The at least one camera 202 is communicably coupled with at least one processor 204. The at least one camera 202 is configured to capture a first video, wherein the first video comprises video frames representing the railway environment. The at least one processor 204 is communicably coupled to the at least one camera 202, wherein the at least one processor 204 is configured to execute steps of the method.

Referring to FIG. 3, there is shown an exemplary process flow 300 for automatic digital inspection of a railway environment, in accordance with an embodiment of the present disclosure. Herein, a first video representing the railway environment is received from a storage 302 for generating a point cloud at a processing pipeline stage 304. Herein, the storage 302 is used to store the first video captured by at least one camera, and the processing pipeline stage 304 is used for point cloud generation. The video comprises video frames representing the railway environment, wherein the video frames are stored at a storage 306, while the point clouds are stored at a storage 308.

Subsequently, an image segmentation model 310 is trained using processing pipeline stage 312, wherein the processing pipeline stage 312 is a training process. The video frames stored at the storage 306 goes through the image segmentation model 310 to attribute labels to each pixel of the video frames for generating annotated video frames. The annotated video frames are stored at a storage 314.

Subsequently, the annotated video frames stored at the storage 314 and their corresponding point clouds stored at the storage 308 are evaluated for at least one violation as determined by a processing pipeline stage 316. An inspection information stored at a storage 318 is generated related to the at least one violation, when it is determined that the at least violation is present in the railway environment. Herein, the processing pipeline stage 316 comprises a list of violations, such as at least one of, high lineside violation, overhead vegetation violation, sign violation, signal violation, safe cess violation, based on which the annotated video frames and their corresponding point clouds are evaluated. The inspection information is sent to a user device, wherein the inspection information is raised as the at least one violation in the user device.

The inspection information is received from the storage 318 for generating a second video at a processing pipeline stage 320. Herein, the processing pipeline stage 320 is used to generate the second video comprising a plurality of annotated video frames that depict the at least one violation, based on the inspection information. Simultaneously, the inspection information is received from the storage 318 for generating a third video at a processing pipeline stage 322. Herein, the processing pipeline stage 322 is used to generate the third video by merging detections of the second video that depict the same violation into a single detection. The second video is stored at a storage 324, and the third video is stored at a storage 326. Consequently, the second video and the third video are sent to a user device 328. All the storages 302, 306, 308, 314, 318, 324, and 326 are a part of a data repository. These storages can be implemented separately or together.

FIG. 3 is merely an example, which should not unduly limit the scope of the claims herein. A person skilled in the art will recognize many variations, alternatives, and modifications of embodiments of the present disclosure.

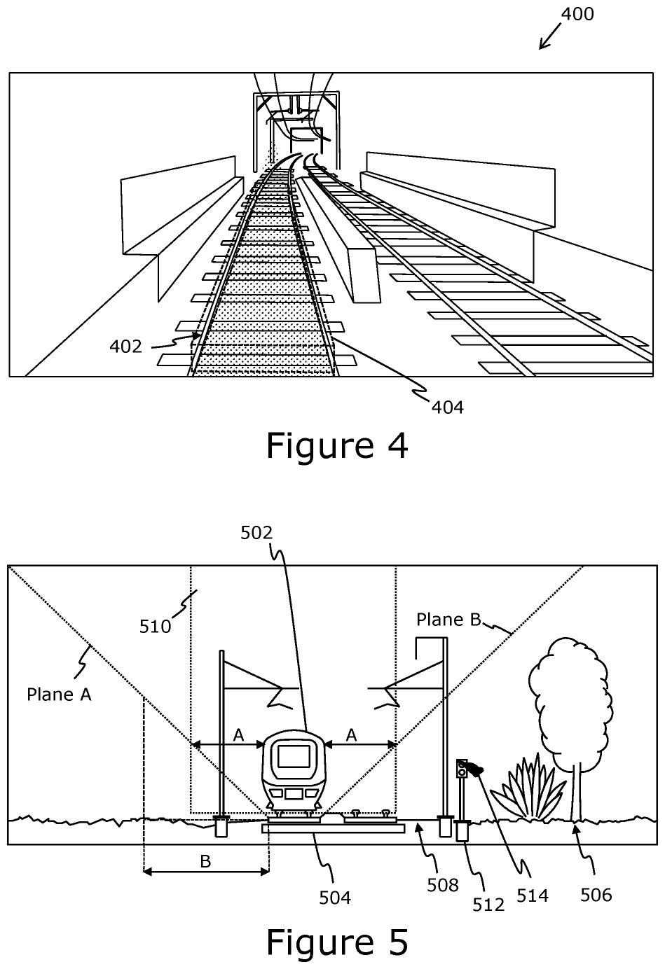

Referring to FIG. 4, there is shown an exemplary railway environment 400, in accordance with an embodiment of the present disclosure. The railway environment 400 comprises a railway track 402. The railway track 402 may be detected in annotated video frames and their corresponding point clouds, and a bounding box 404 may be drawn in the annotated video frames, wherein the bounding box 404 is fitted to the railway track 402. Subsequently, it is determined whether at least one violation is present in the railway environment 400 when violation conditions are satisfied in respect to the bounding box 404.

FIG. 4 is merely an example, which should not unduly limit the scope of the claims herein. A person skilled in the art will recognize many variations, alternatives, and modifications of embodiments of the present disclosure.

Referring to FIG. 5, there are shown exemplary violations in a railway environment, in accordance with an embodiment of the present disclosure. The violations may be high lineside violation, safe cess violation, overhead vegetation violation and so forth. The railway environment may comprise a rail vehicle 502, a railway track 504, vegetation 506 and a cess 508. Two planes, namely Plane A and Plane B extend obliquely from two rails of the railway track 504. The angle between the Plane A or Plane B corresponding to a given rail and a ground surface may be 45 degrees. Notably, any obstruction that may be present in a first space 510 (between the plane A and the rail vehicle 504) is detected as the high lineside violation. The first space 510 is defined by the two planes (Plane A and Plane B), and extends within a predefined distance from the two rails. The predefined distance may, for example, be equal to 2 metres.

In case any obstruction is present beyond the predefined distance (for example, at a distance of 6 metres (as denoted by line B)) from the railway track 504 but in-between the planes A and B, the obstruction is not detected as the high lineside violation but is detected as a reduced sign or signal visibility or the safe cess violation. Herein, when the cess 508 adjacent to the railway track 504 is obstructed at least partially such that a distance between a non-obstructed region of the cess 508 and the railway track 504 is less than a predefined safety distance, then an unsafe situation (i.e., accidents and so forth) is created for the track workers.

In this regard, a violation is not detected when vegetation 506 is present in the railway environment as shown in the figure. However, in case the vegetation 506 extends above the railway track 504, such as for example, branches of a tree present in the vegetation 506 extend in a manner that the branches lie above the railway track 504, an overhead vegetation violation would be detected.

Furthermore, the railway environment may comprise a signal 512. As an example, the signal 512 may be partially or fully obscured by an object 514. This results in a signal violation.

FIG. 5 is merely an example, which should not unduly limit the scope of the claims herein. A person skilled in the art will recognize many variations, alternatives, and modifications of embodiments of the present disclosure.

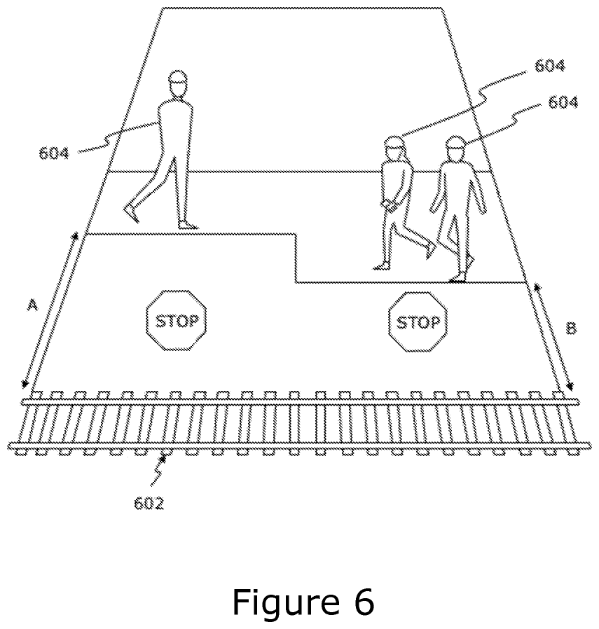

Referring to FIG. 6, there is shown an exemplary safe cess in a railway environment, in accordance with an embodiment of the present disclosure. A safe cess is adjacent to a railway track 602 in the railway environment. The safe cess allows track workers 604 to safely transit the railway environment at a predefined safe area which is at a predefined distance (depicted as A and B) from the railway track 602. The predefined safety distance depends on a maximum speed at which a rail vehicle is permitted to run on the railway track 602. Herein, the predefined safety area lies in a range of 2 metres to 2.75 metres when the maximum speed is equal to or greater than 100 miles per hour (depicted as the area above A) Furthermore, the predefined safety area lies in a range of 1.25 metres to 2 metres when the maximum speed is less than 100 miles per hour.

FIG. 6 is merely an example, which should not unduly limit the scope of the claims herein. A person skilled in the art will recognize many variations, alternatives, and modifications of embodiments of the present disclosure.

1. A method for automatic digital inspection of a railway environment, the method comprising:
receiving at least a first video captured by at least one camera mounted on a rail vehicle, wherein the first video comprises video frames representing the railway environment;
generating point clouds using the video frames, wherein a given point cloud corresponds to a given set of video frames;
attributing labels to each pixel of the video frames for generating annotated video frames;
evaluating the annotated video frames and their corresponding point clouds using a set of predefined rules to at least determine whether or not at least one violation is present in the railway environment;
generating inspection information related to the at least one violation, when it is determined that the at least one violation is present in the railway environment; and
sending the inspection information to a user device.

2. The method of claim 1, further comprising:
generating a second video comprising a plurality of annotated video frames that depict the at least one violation, based on the inspection information; and
sending the second video to the user device.

3. The method of claim 2, further comprising adding one or more video frames of the first video in the second video.

4. The method of claim 2, wherein the method further comprises:
merging detections in the second video that depict the same violation into a single detection, based on the location of the at least one violation and its bounding box and on a temporal adjacency between the detections in the second video, to obtain a third video, wherein the third video comprises a lesser number of detections as compared to the second video; and
sending the third video to the user device for display thereat.

5. The method of claim 1, further comprising receiving LiDAR data captured by a LiDAR scanner, wherein the LiDAR data is used for generating the point clouds and for evaluating the annotated video frames and their corresponding point clouds.

6. The method of claim 1, wherein the inspection information is in form of at least one of:
an annotated image representing the at least one violation and its bounding box; and
a file including at least one property of the at least one violation, wherein the at least one property is at least one of: a type, a location, a size, a time-point of occurrence in the first video, of the at least one violation.

7. The method of claim 1, further comprising training an image segmentation model using a machine learning algorithm, wherein upon training, the image segmentation model learns to perform the step of attributing the labels to each pixel of the video frames for generating the annotated video frames.

8. The method of claim 1, wherein the step of evaluating the annotated video frames and their corresponding point clouds comprises:
detecting a railway track in the annotated video frames and their corresponding point clouds, and drawing a bounding box in the annotated video frames, wherein the bounding box is fitted to the railway track;
associating the labels attributed to pixels of the annotated video frames to corresponding points within the point clouds; and
determining that the at least one violation is present in the railway environment when violation conditions specified in the set of predefined rules is satisfied in respect of the bounding box.

9. The method of claim 1, wherein the set of predefined rules comprises at least one geometric rule and/or at least one custom-defined rule, the set of predefined rules comprising at least one of:
determining that a high lineside violation is present when vegetation is present in a first space that is defined by two planes extending obliquely within a predefined distance from two rails of a railway track
determining that an overhead vegetation violation is present when vegetation is present in a second space lying vertically above the railway track;
determining that a sign violation is present when a given sign in the railway environment is at least one of: obscured by another object, unreadable, vandalised;
determining that a signal violation is present when a given signal in the railway environment is at least one of: obscured by another object, malfunctioning, vandalised;
determining that a safe cess violation is present when a cess adjacent to the railway track is obstructed at least partially such that a distance between a non-obstructed region of the cess and the railway track is less than a predefined safety distance; and
determining that a scrap rail violation is present when scrap rail is present on or in proximity of the railway track.

10. The method of claim 9, wherein the predefined safety distance depends on a maximum speed at which the rail vehicle is permitted to run on the railway track, and wherein:
the predefined safety distance lies in a range of 2 metres to 2.75 metres when the maximum speed is equal to or greater than 100 miles per hour; and
the predefined safety distance lies in a range of 1.25 metres to 2 metres when the maximum speed is less than 100 miles per hour.

11. A system for automatic digital inspection of a railway environment according to the method of claim 1, the system comprising:
at least one camera that is configured to capture a first video, wherein the first video comprises video frames representing the railway environment; and
at least one processor communicably coupled to the at least one camera, wherein the at least one processor is configured to execute steps of the method.

12. The system of claim 11, wherein the at least one camera is mounted on at least one of:
a side of a rail vehicle;
a fixed object present in the railway environment; and
a movable object present in the railway environment.

13. The system of claim 11, wherein the system further comprises a data repository communicably coupled to the at least one processor and/or the at least one camera, wherein the data repository is configured to store at least one of: the first video, point clouds generated using the video frames, labels attributed to each pixel of the video frames, a set of predefined rules, inspection information, a second video, a third video.

14. A computer program product for automatic digital inspection of a railway environment, the computer program product comprising a non-transitory machine-readable data storage medium having stored thereon program instructions that, when accessed by a processing device, cause the processing device to execute steps of the method of claim 1.
